(19) United States
(12) Patent Application Publication
(10) Pub. No.: US 2015/0077368 A1
(43) Pub. Date: Mar. 19, 2015

(54) TOUCH CONTROL PANEL AND TOUCH DISPLAY DEVICE

(71) Applicant: Wintek Corporation, Taichung City (TW)

(72) Inventors: Chun-Ho Chen, Changhua County (TW); Chong-Wei Li, Changhua County (TW)

(21) Appl. No.: 14/487,111

(22) Filed: Sep. 16, 2014

(30) Foreign Application Priority Data
Sep. 17, 2013 (TW) 102133626

(51) Int. Cl. G06F 3/041; G06F 1/16

(52) U.S. Cl. CPC G06F 3/0412; G06F 1/1643
USPC 345/173

(57) ABSTRACT

A touch control panel includes a substrate, a touch-control element and a connection part. The substrate has a main portion and a protrusion portion positioned at a side of the main portion. The touch-control element is disposed on the main portion of the substrate and includes a conductive electrode and an electrode wire. The connection part is disposed on the protrusion portion of the substrate, including at least one connecting wire electrically connected to the electrode wire and positioned on the substrate. The connection part is used for coupling the touch-control element to an external system such that the sensing signal of the touch-control element can be delivered to the external system directly through the connecting wire of the connection part without any additional circuit board.

### BACKGROUND OF THE INVENTION

1. Field of the Invention

The present invention relates to a touch control panel, and more particularly, to a touch control panel integrating the touch-control element and the circuit board.

2. Description of the Prior Art

Touch panels have been widely used in various electronic products, such as mobile phones, GPS navigator system, tablet PCs, personal digital assistants (PDA), and laptop PCs, due to the human-machine interaction property thereof.

Generally, a flexible printed circuit board is needed for electrically connecting the touch-control element to an external system in conventional art, and therefore a bonding process of the flexible printed circuit board is requested during the assembling, so as to electrically connect the wire(s) of the flexible printed circuit board to the bonding pad(s) of the touch-control element. However, since the relative position alignment and the material of the bonding pad, as well as the parameter of machine, have to be taken into consideration in the bonding process of the circuit board, the arrangement and design of the wires of the touch-control element and the flexible print circuit board are limited. Hence, to provide a solution to achieve the fabrication through a time-and-cost saving process and to improve the aforementioned issues is still a major objective in the field.

### SUMMARY OF THE INVENTION

It is one of the primary objectives of the present invention to provide a touch control panel, which integrates the touch-control element and the circuit board which is configured to couple the touch-control element to an external system, such that a flexible print circuit board is no longer needed to be further attached to the touch control panel, thereby reducing the total fabrication process to save the cost spent on the attaching materials and heavy works and increasing the yield.

To achieve the purpose described above, the present invention provides a touch control panel, including a substrate, a touch-control element, and a connection part. The substrate includes a main portion and a protrusion portion positioned at a side of the main portion. The touch-control element is disposed at the main portion of the substrate and includes a light transmittance region and a periphery region positioned at least at a side of the light transmittance region. The touch-control element includes at least one conductive electrode and an electrode wire. The conductive electrode is disposed on a surface of the substrate and positioned at least in the light transmittance region; and the electrode wire is disposed in the periphery region and is electrically connected to the conductive electrode. The connection part is disposed on the protrusion portion of the substrate and includes at least one connecting wire positioned on the surface of the substrate and being electrically connected to the electrode wire. The connection part is used for coupling the touch-control element to an external system, such that sensing signals of the touch-control element can be delivered to the external system directly through the connecting wire without passing through any additional circuit board.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic top view illustrating a touch control panel according to a first embodiment of the present invention.

FIG. 2 is a schematic side view of the touch control panel shown in FIG. 1.

FIG. 3 is a schematic top view illustrating a touch control panel according to a variant embodiment of the first embodiment of the present invention.

FIG. 4 is a schematic top view illustrating a touch control panel according to a second embodiment of the present invention.

FIG. 5 is a schematic side view of the touch control panel shown in FIG. 4.

FIG. 6 is a schematic top view illustrating a touch control panel according to a third embodiment of the present invention.

FIG. 7 is a schematic side view of a touch display device of the present invention.

### DETAILED DESCRIPTION

To provide a better understanding of the present invention to users skilled in the technology of the present invention, preferred embodiments are detailed as follows. The preferred embodiments of the present invention are illustrated in accordance with the accompanying figures to clarify the contents and effects to be achieved.

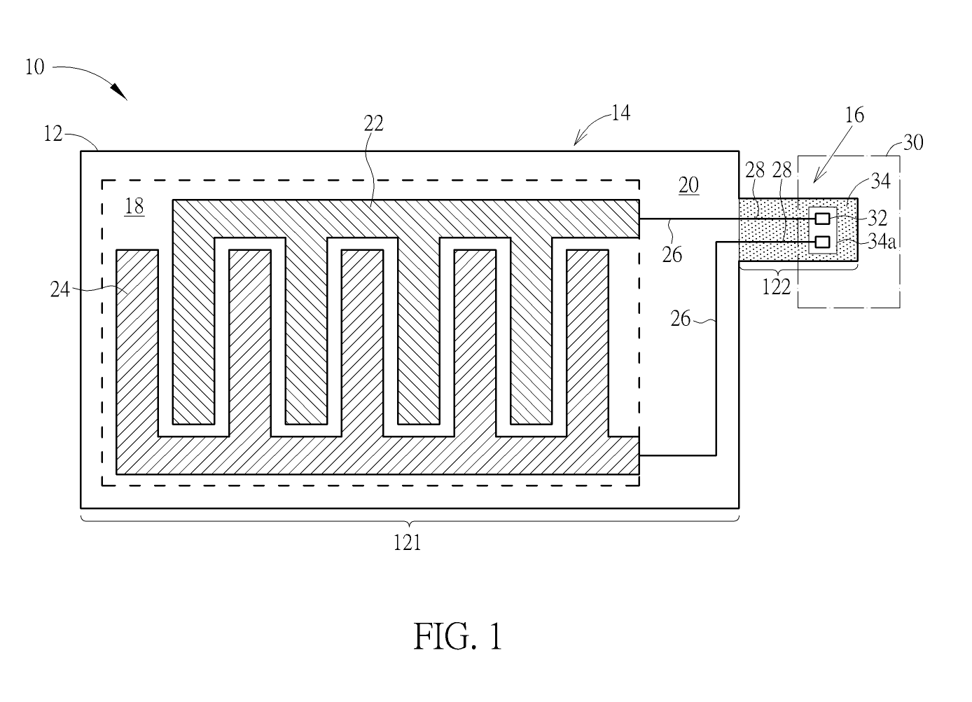

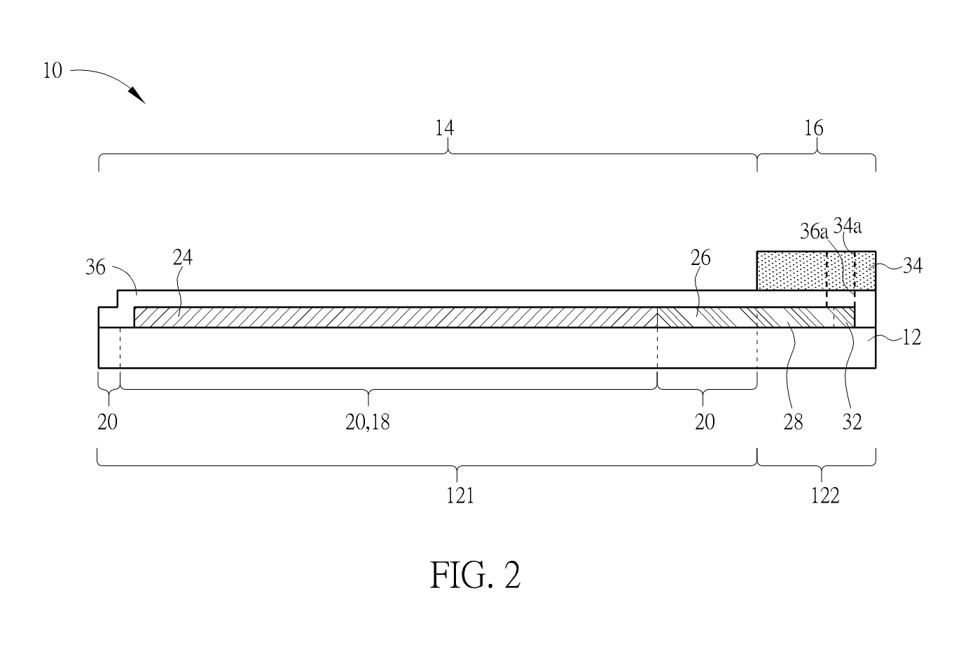

Referring to FIG. 1 and FIG. 2, FIG. 1 is a schematic top view illustrating a touch control panel according to a first embodiment of the present invention, and FIG. 2 is a schematic side view only illustrating the touch control panel shown in FIG. 1, without illustrating an external system. A touch control panel 10 according to the first embodiment of the present invention includes a substrate 12, a touch-control element 14, and a connection part 16. The substrate 12 includes a main portion 121 and a protrusion portion 122, wherein the protrusion portion 122 is positioned at a side of the main portion 121. In a preferred embodiment, the size of the main portion 121 is greater than the size of the protrusion portion 122 of the substrate 12, and the protrusion portion 122 protrudes from a side of the main portion 121, but not limited thereto. In the present embodiment, the substrate 12 is a flexible substrate, for example a polyethylene terephthalate (PET) substrate/film or a polyimide (PI) substrate/film, but not limited thereto. However, the substrate 12 may also be a rigid substrate. Furthermore, the substrate 12 is preferably a transparent substrate, such that the substrate 12 of the touch control panel 10 according to the present invention can be used as a cover lens of a touch display product. Therefore, a display panel can be further disposed on the back side of the touch control panel 10 to allow the substrate 12 to cover on the display panel, thereby the bottom side of the substrate 12 shown in FIG. 2 is used as a touch control surface for the user. However, in other embodiments, a transparent cover lens, such as a glass substrate, can also be disposed on the top side of the substrate 12, and the top side of the substrate 12 shown in FIG. 2 is used as a touch control surface for the user. Otherwise, the substrate 12 can be used as a substrate of a display device, such as a color filter substrate of a liquid crystal display device or an assembly cover-substrate of an organic light emitting device.

On the other hand, the touch-control element 14 of the touch control panel 10 according to the present embodiment is disposed at the main portion 121 of the substrate 12, and includes a light transmittance region 18 and a periphery region 20. The periphery region 20 is positioned at least at one side of the light transmittance region 18. In the present embodiment, the periphery region 20 is positioned at a periphery of the light transmittance region 18 and surrounds the light transmittance region 18, but not limited thereto. The touch-control element 14 includes at least one conductive electrode and at least one electrode wire. As shown in FIG. 1, the touch-control element 14 includes two comb-shaped conductive electrodes 22, 24 disposed on the surface of the substrate 12 and at least positioned in the light transmittance region 18. The comb-shaped portions (or tooth-shaped portions) of the two conductive electrodes 22, 24 are spaced from each other. Preferably, the material of the conductive electrodes 22, 24 is a conductive layer having visual transparence, for example metallic oxide material layer, or metal material layer, but not limited thereto. Wherein, the aforementioned metal material layer may include at least one of aluminum, copper, silver, chromium, titanium, and molybdenum, a composition layer of at least one of the aforementioned materials, or a stack layer of at least two of the aforementioned materials, or an alloy layer of at least two of the aforementioned materials, but not limited thereto, and the aforementioned metal material layer may include mesh-like shapes, such as metal mesh structure. In addition, the aforementioned conductive layer may also include conductive particles, carbon nanotubes, graphene, silicone, or nanoscaled metal wire, such as nano silver, but not limited thereto, and the aforementioned conductive layer may also include mesh-like shape, such as conductive mesh structure. The line width of the aforementioned metal mesh structure or the conductive mesh structure is substantially between 0.5 micrometers (μm) and 8 micrometers, and the unit area thereof has an aperture ratio of light transmittance is up to 85% or greater than 85%. The aforementioned metal mesh structure can be manufactured by the process of lithography, spray-printing, or coating, or forming trenches through stamping process and then filling metal therein. The aforementioned metal mesh structure may include single layer or multilayer structure, and an anti-reflection layer, a hazing layer or a blackening layer may be optionally disposed on its surface facing to the user, for reducing the reflectance. The touch control panel 10 further includes at least one electrode wire (s) 26 disposed in the periphery region 20. In FIG. 1, two electrode wires 26 being respectively corresponding to and electrically connected to the conductive electrodes 22, 24 are exemplified, but not limited thereto. Preferably, the material of the conductive electrode 26 is a conductive material having good conductivity, such as metal material(s). Additionally, the electrode wires 26 may include one or more conductive layers. In a preferred embodiment, the material of the conductive material(s) for composing the conductive layer(s) of the electrode wires 26 may include at least one of aluminum, copper, silver, chromium, titanium, molybdenum, neodymium, and gold, an alloy of at least one of the aforementioned materials, a composition layer of the aforementioned materials or a composition layer of at least one of the aforementioned materials and an alloy of at least one of the aforementioned materials, but not limited thereto. It should be noted that, the number, arrangement, disposed position and the number of the layer(s) of the conductive electrodes and the electrode wire shown in FIG. 1 are only for illustration, which is not adapted to limit the relative positions of the conductive electrodes and the electrode wire of the present invention, and the conductive electrodes may include any other shapes, such as rhombus, rectangle, or triangle, but not limited thereto. In addition, in other embodiments, the connecting condition of the electrode wires 26 and the conductive electrodes 22, 24 are not limited to what is illustrated in FIG. 1 and FIG. 2. For example, in another embodiment, a portion of the conductive electrodes 22, 24 may extend to the periphery region 20 and cover the corresponding electrode wires 26, or the electrode wires 26 may cover a portion of the conductive electrodes 22, 24 respectively in the periphery region 20, thereby electrically connecting the electrode wires 26 and the conductive electrodes 22, 24 to each other.

Furthermore, the connection part 16 of the touch control panel 10 is disposed at the protrusion portion 122 on the surface of the substrate 12. The connection part 16 includes at least one connecting wire(s) 28 disposed on the surface of the substrate 12 and being electrically connected to one electrode wire 26. In the present embodiment, each electrode wire 26 is corresponding to and electrically connected to one connecting wire 28 respectively, but not limited thereto. As shown in the top view, each electrode wire 26 may be positioned between the corresponding connecting wire 28 and the corresponding conductive electrode 22 or 24 in order to electrically connecting the corresponding connecting wire 28 and conductive electrode 22 or 24. In a preferred embodiment, the connecting wires 28 and the electrode wires 26 are composed of the same conductive material, and are fabricated through the same fabrication process. Therefore, the material of the connecting wires 28 are preferably the same as the aforementioned material(s) of the electrode wires 26, which will not be further detailed. In one embodiment of the present invention, a PET substrate may be selected for serving as the substrate 12, the material of wires may be copper or molybdenum/aluminum/molybdenum, and the patterns of the electrode wires 26 and the connecting wires 28 may be defined through a vacuum sputtering process and a photolithography process. In other embodiments, the electrode wires 26 and the connecting wires 28 may be fabricated through a screen printing process.

In addition, the connection part 16 may further include one or more bonding pads 32 electrically connected to the connecting wires 28, wherein the bonding pads 32 are disposed on the surface of the substrate 12, thereby coupling the connection part 16 to an external system 30 through the bonding pads 32. The material of the bonding pads 32 may be the same as the connecting wires 28. For example, the bonding pads 32 may be composed of the same material as the connecting wires 28, or be fabricated through the same fabrication process of the connecting wires 28, but not limited thereto. The fabrication process and the material of the bonding pads 32 may be carried out or provided additionally in various embodiments. Moreover, the connection part 16 may optionally include a protection layer 34 disposed on the surface of the protrusion portion 122 of the substrate 12, and the protection layer 34 covers the connecting wires 28 to shelter the connecting wires 28. In addition, the protection layer 34 has at least one opening(s) 34a to expose at least one portion of the bonding pads 32, such that the bonding pads 32 can contact to the external system 30 or other electrical elements in order to achieve coupling effect, thereby providing signal delivery function. In the present embodiment, the touch control panel 10 may optionally further include an insulation layer 36, which is entirely disposed on the surface of the substrate 12, both on the main portion 121 and the protrusion portion 122, to cover the conductive electrodes 22, 24, the electrode wires 26 and the connecting wires 28. The insulation layer 36 preferably has an opening 36a which is corresponding to the opening 34a of the protection layer 34, so as to expose at least one portion of the bonding pads 32. In other embodiments, the connection part 16 may include other protection layers disposed thereon according to the practical requirement, so as to provide further protection to the connection part 16.

The connection part 16 of the touch control panel 10 of the present invention is configured to couple the touch-control element 14 to the external system 30, so that the sensing signals of the touch-control element 14 can be directly delivered to the external system 30 through the connecting wires 28 of the connection part 16, without passing through other circuit board(s). Specifically, since the substrate material and the wiring material of the connection part 16 of the touch control panel 10 according to the present invention are similar to those of the flexible print circuit board, the connection part 16 can replace the flexible print circuit board or other types of circuit boards used for coupling the touch-control element to an external system in the convention touch control panel. Therefore, when the touch control panel 10 of the present invention is assembled to other control devices, an additional external circuit board is no longer needed to be disposed between the touch control panel 10 and other control devices. Therefore, the process of conjugating the external circuit board and the touch-control element in the entire assembling process of the electronic product is omitted. Wherein, the aforementioned external system 30 for example is a control unit, a connector, a print circuit board, or a systemic board including a driving chip, but not limited thereto. It is noted that, in a preferred embodiment, the substrate 12 is a flexible substrate or a pliable substrate, and at least the connecting wires 28 have pliability, such that the entire connection part 16 can be pliably bended toward the external system 30 for being coupled to the external system 30 according to the practical requirement of assembling.

The touch control panel of the present invention is not limited to the aforementioned embodiments. The following description will detail the other embodiments or variant embodiments of the present invention. To simplify the description, the following description will detail the dissimilarities among those embodiments and the variant embodiments, and the identical features will not be redundantly described. In order to compare the differences between the embodiments easily, the identical components in each of the following embodiments are marked with identical symbols.

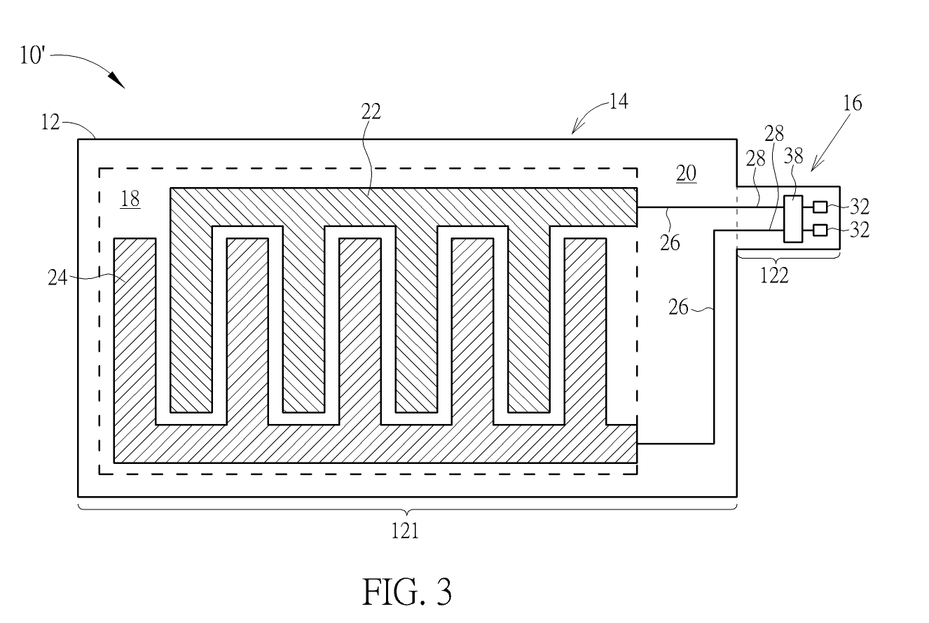

Referring to FIG. 3, in a variant embodiment of the first embodiment, the connection part 16 of the touch control panel 10′ may further include a circuit control element 38, such as an integrated circuit chip. The circuit control element 38 is disposed on the surface of the protrusion portion 122 of the substrate 12 and is electrically connected to the connecting wires 28, for receiving the sensing signals delivered from the touch-control element 14 or other signals delivered from the external system 30, such that the user can manipulate the touch control panel 10′. The electrical connection between the circuit control element 38 and the connecting wires 28 may be similar to the connection of the chips in the convention flexible print circuit board, for example (but not limited to) using bonding pad or anisotropic conductive film for bonding these two elements, which will not be further detailed in the present specification.

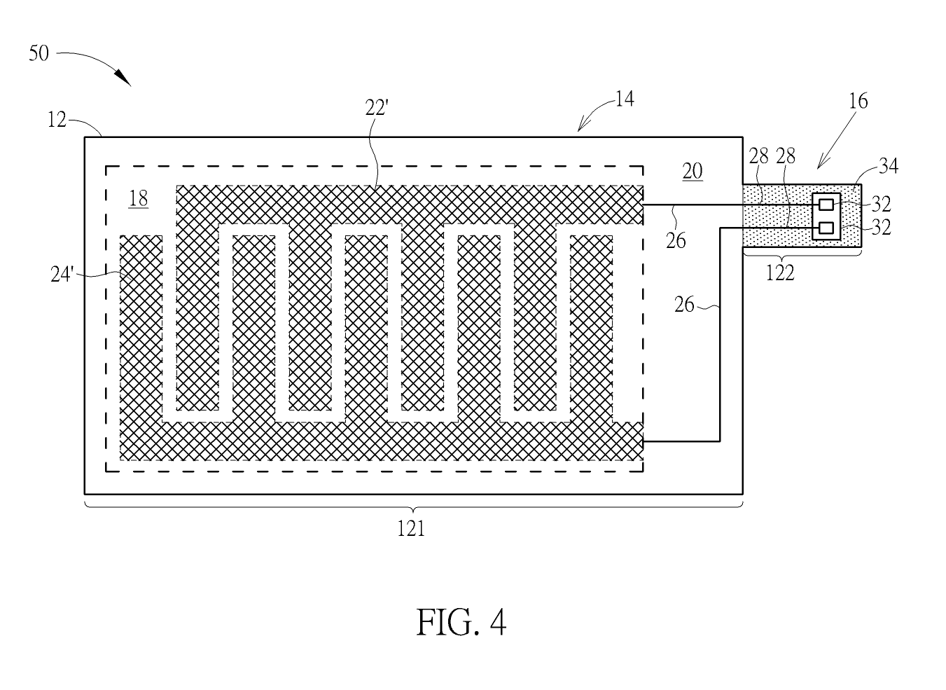

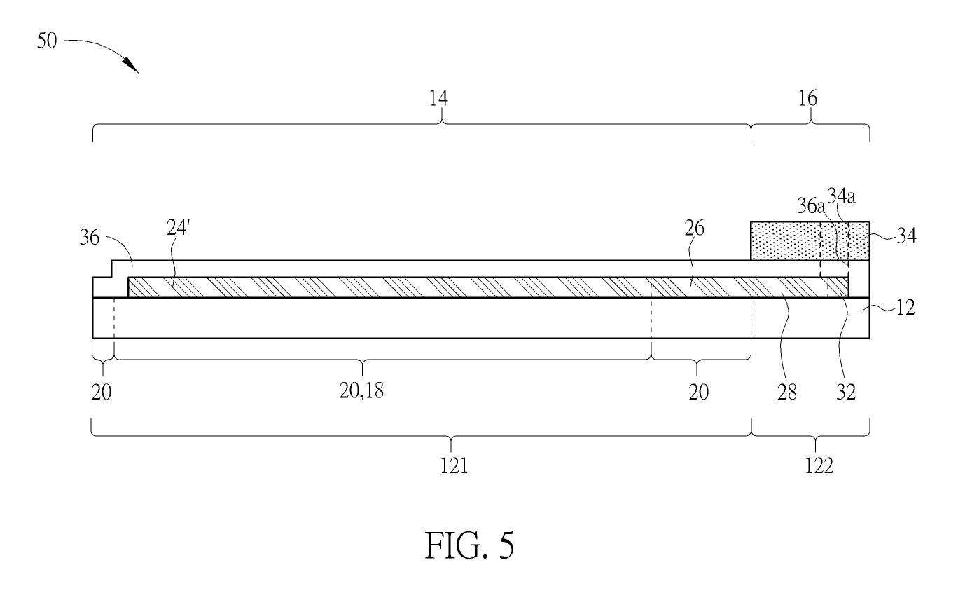

Referring to FIG. 4 and FIG. 5, the touch control panel 50 according to a second embodiment of the present invention is different from the first embodiment in that the conductive electrodes 22′, 24′ are composed of metal layer, and the metal layer includes metal mesh structure. With such design, the conductive electrodes 22′, 24′, the electrode wires 26 and the connecting wires 28 may all be fabricated from the same single layer of metal layer or multilayered metal layer, and the aforementioned three elements can be fabricated through the same fabrication process. For example, a vacuum sputtering process and a photolithography process may be used for defining the patterns of the shape and the metal mesh structures of the conductive electrodes 22′, 24′ and the wiring patterns of the electrode wires 26 and the connecting wires 28 at the same time. In addition, the material for composing the conductive electrodes 22′, 24′, the electrode wires 26 and the connecting wires 28 may be referred to the materials of the electrode wires 26 in the first embodiment, which will not be further detailed. The advantage of the present embodiment is in that the conductive electrodes 22′, 24′, the electrode wires 26 and the connecting wires 28 are all composed of the same metal layer, such that the fabrication process can be simplified and the cost of the materials can be reduced, and the electrical conductivity of the conductive electrodes 22′, 24′ can be further improved. It is noted that, the outward-shape patterns of the conductive electrodes 22′, 24′ are not limited to the illustration in FIG. 4 and may have the patterns of rectangle, rhombus, or triangle, for example. Furthermore, similar to the variant embodiment of the first embodiment, the touch control panel 50 may further include a circuit control element (not shown in the figure) disposed in the connection part 16, which will not be further detailed. In other embodiment, the conductive electrodes 22′, 24′ may respectively include electrodes connected in a series, wherein the serial electrodes cross each other with an insulation layer or an insulation element and a bridge structure being disposed at the crossing portions for electrically isolating the conductive electrodes 22′, 24′ from each other.

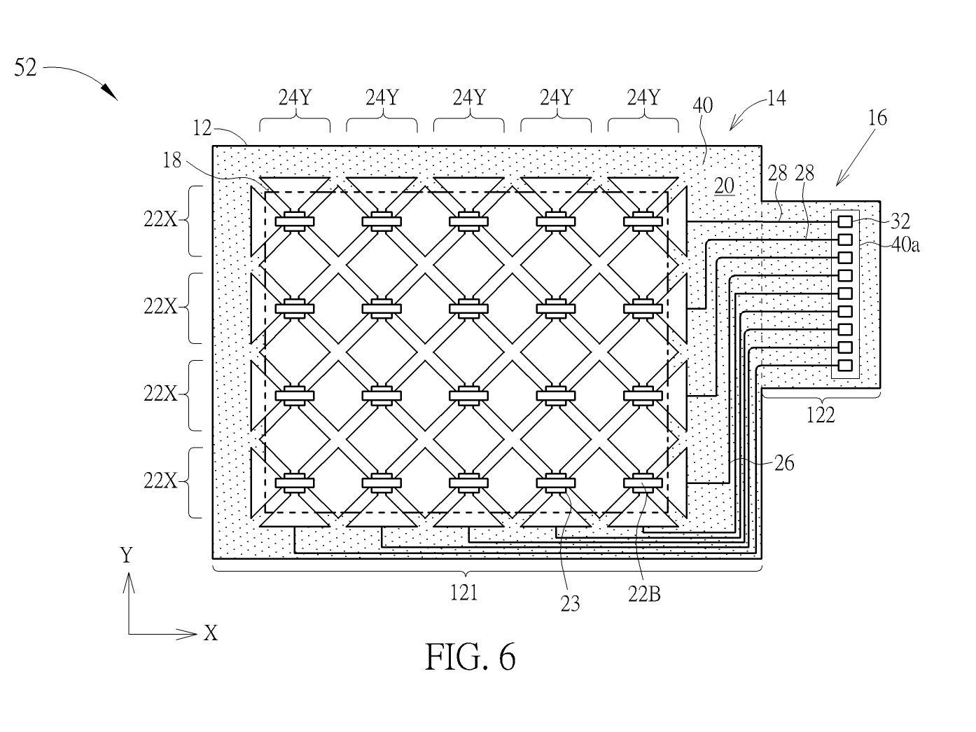

As shown in FIG. 6, the touch control panel 52 according to a third embodiment of the present invention is different from the second embodiment in that the conductive electrodes include first axis electrodes 22X and second axis electrodes 24Y extending along a X direction and a Y direction, perpendicular to the X direction, respectively. Also, an insulation element 23 is further disposed at each of the crossing portions between each first axis electrode 22X and each second axis electrode 24Y, so that the first axis electrodes 22X and the second axis electrodes 24Y are electrically isolated from each other. Wherein, each first axis electrode 22X includes bridge wires 22B disposed on the upper sides of the insulation elements 23 for electrically connecting each conductive electrode unit to each other in the same first axis electrode 22X. Moreover, the touch control panel 52 further includes a decoration layer 40 disposed on the surface of the substrate 12. The decoration layer 40 is positioned in the periphery region 20 of the main portion 121 and the protrusion portion 122 (the protection layer 34 is omitted in FIG. 6 for easy recognizing the elements showing the drawings). The decoration layer 40 functions to beautify the appearance of the touch control panel 52. In another embodiment, the decoration layer 40 may be disposed only in the periphery region 20 or in at least one part of the periphery region 20, without being disposed in the protrusion portion 122.

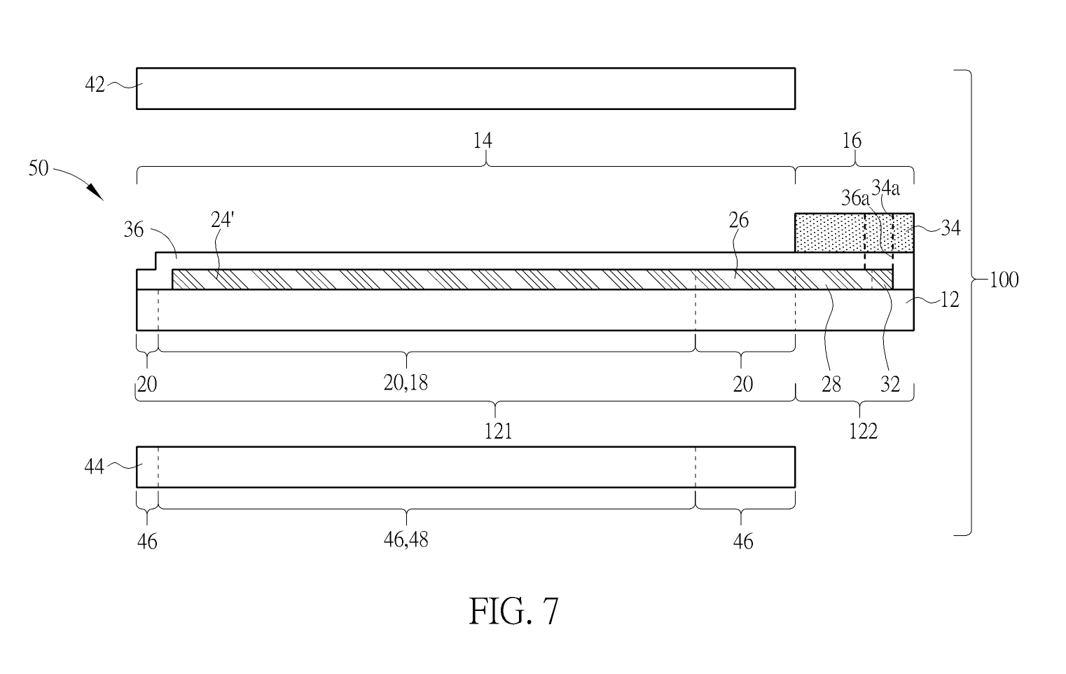

Referring to FIG. 7, FIG. 7 is a schematic side view of a touch display device according to one embodiment of the present invention. The aforementioned touch control panels of the present invention can be applied to any touch display device, and FIG. 7 exemplifies a touch display device 100 including the touch control panel 50 shown in FIG. 5. In the present embodiment, the touch display device 100 includes a cover lens 42, a touch control panel 50 and a display panel 44 disposed from bottom to top. The cover lens 42 is corresponding to the touch-control element 14 (namely, the main portion 121 of the substrate 12 in the touch control panel 50) and the display panel 44, to provide protection function. The material of the cover lens 42 for example is glass. The display panel 44 includes a display region 48 and a peripheral circuit region 46, corresponding to the light transmittance region 18 and the periphery region 20 of the touch control panel 50 respectively. The display panel 44 may be any type of display panel, such as liquid crystal display panel, organic light-emitting diode panel and electrophoretic display panel, but not limited thereto. It should be noted that, in different embodiments, the substrate 12 of the touch control panel 50 itself can be used as a cover plate, such that the cover lens 42 can be omitted. In such design, the touch control panel 50 can be disposed upside down on the top of the display panel 44 for positioning the conductive electrodes 22′, 24′ between the substrate 12 and the display panel 44.

It should be noted that the wiring design of the connecting wire in the connection part is not limited to what is disclosed in the aforementioned embodiments. For example, if the connection part has a plurality of connecting wires, those connecting wires may be disposed in a multilayered structure or be disposed in two or more layers, such as that some of the connecting wires are disposed directly on the surface of the protrusion portion of the substrate, with an insulation layer disposed thereon, and the other connecting wires are disposed on the insulation layer. The advantage of disposing the connecting wires in the multilayered structure includes that the area of the connection part can be dramatically reduced and the arrangement design of the connecting wires is flexible according to practical requirement. In addition, some specific connecting wires can be electrically connected to each other in the multilayered connecting wire, for example using the contact holes in the insulation layer(s) to electrically connect the connecting wires in different layers. When the connecting wires are formed in a multilayered structure, the fabrication thereof can be carried out accompanied with the fabrication of the touch-control element having the double-layered conductive electrodes or having the bridge structure and the insulation layer or element.

Through the aforementioned description, the connection part and the touch-control element of the touch control panel in the present invention shares the same substrate, with the connection part replacing the circuit board in conventional art, so that the conjugation process or bonding process of the circuit board and other following processes can be omitted. As a result, the alignment issue for the boding process can be avoided, and the limitation problem of the wiring design of the touch-control element due to the bonding process is solved. In addition, the fabrication processes of the wires of the connection part and the touch-control element can be integrated together, so as to effectively simplify the fabrication steps and the entire cost of the fabrication.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A touch control panel, comprising:
a substrate, comprising a main portion and a protrusion portion, the protrusion portion being positioned at a side of the main portion;
a touch-control element, disposed at the main portion of the substrate, the touch-control element having a light transmittance region and a periphery region positioned at least at a side of the light transmittance region, and the touch-control element comprising:
at least one conductive electrode, disposed on a surface of the substrate and positioned at least in the light transmittance region; and
an electrode wire, disposed in the periphery region and electrically connected to the conductive electrode; and
a connection part, disposed on the protrusion portion of the substrate, the connection part comprising at least one connecting wire positioned on the substrate and electrically connected to the electrode wire, and the connection part being used for coupling the touch-control element to an external system, such that sensing signals of the touch-control element being delivered to the external system directly through the connecting wire without passing through any additional circuit board.

2. The touch control panel according to claim 1, wherein the substrate is a flexible substrate.

3. The touch control panel according to claim 2, wherein the substrate comprises at least one of polyethylene terephthalate (PET) and polyimide (PI).

4. The touch control panel according to claim 1, wherein the substrate is a transparent substrate.

5. The touch control panel according to claim 1, wherein the electrode wire and the connecting wire are composed of a same conductive layer.

6. The touch control panel according to claim 5, wherein the conductive electrode, the electrode wire and the connecting wire are composed of the same conductive layer.

7. The touch control panel according to claim 6, wherein the conductive layer comprises a conductive mesh structure.

8. The touch control panel according to claim 5, wherein a material of the conductive layer comprises at least one of aluminum, copper, silver, chromium, titanium, molybdenum, neodymium and gold, an alloy of at least one of said materials, a composition layer of said materials or a composition of at least one of said materials and an alloy of at least one of said materials.

9. The touch control panel according to claim 5, wherein the conductive layer comprises a single layer structure or a multilayer structure.

10. The touch control panel according to claim 1, wherein a size of the main portion is greater than a size of the protrusion portion, and the protrusion portion protrudes from a side of the main portion.

11. The touch control panel according to claim 1, further comprising an insulation layer covering the conductive electrode, the electrode wire and the connecting wire.

12. The touch control panel according to claim 1, wherein the connection part further comprises:
a bonding pad, disposed on the substrate and electrically connected to the connecting wire, wherein the connection part is electrically connected to the external system through the bonding pad; and
a protection layer, disposed on the protrusion portion of the substrate and covering the connecting wire, and the protection layer having an opening for exposing at least one portion of the bonding pad.

13. The touch control panel according to claim 1, wherein the connection part further comprises a circuit control element, the circuit control element is disposed on a surface of the protrusion portion of the substrate, and the circuit control element is electrically connected to the connecting wire.

14. The touch control panel according to claim 1, further comprising a decoration layer, the decoration layer being positioned on the substrate and at least positioned in the periphery region.

15. The touch control panel according to claim 14, wherein the decoration layer is disposed in the periphery region and the protrusion portion of the substrate.

16. A touch display device, comprising:
a touch control panel according to claim 1; and
a display panel, disposed on a side of the touch control panel.

17. The touch display device according to claim 16, wherein the display panel comprises a periphery circuit region and a display region corresponding to the periphery region and the light transmittance region of the touch control panel respectively.

18. The touch display device according to claim 16, further comprising a cover lens disposed on the touch control panel.

19. The touch display device according to claim 16, wherein the conductive electrode is positioned between the substrate and the display panel.

20. The touch display device according to claim 16, further comprising a decoration layer, the decoration layer being disposed on the substrate and at least positioned in the periphery region.
